(19) United States
(12) Patent Application Publication
(10) Pub. No.: US 2019/0329999 A1
(43) Pub. Date: Oct. 31, 2019

(54) MULTI-FEED DETECTION DEVICE AND ELECTRONIC DEVICE

(71) Applicant: Seiko Epson Corporation, Tokyo (JP)

(72) Inventor: Eiji OSAWA, Chino (JP)

(21) Appl. No.: 16/396,139

(22) Filed: Apr. 26, 2019

(30) Foreign Application Priority Data
Apr. 27, 2018 (JP) 2018-086429

(51) Int. Cl. B65H 7/12; G01B 17/02

(52) U.S. Cl. CPC B65H 7/125; G01B 17/02

(57) ABSTRACT

A multi-feed detection device includes a transmission circuit substrate on which an ultrasonic transmitter transmitting an ultrasonic wave is installed, and an ultrasonic receiver having a receiving surface which receives the ultrasonic wave. The ultrasonic transmitter transmits the ultrasonic wave in a direction intersecting a thickness direction of the transmission circuit substrate, and a cross-section of the ultrasonic wave orthogonal to an advancing direction of the ultrasonic wave is wider than the receiving surface seen from the advancing direction of the ultrasonic wave.

The present application is based on and claims priority from JP Application Serial Number 2018-086429, filed Apr. 27, 2018, the disclosure of which is hereby incorporated by reference herein in its entirety.

### BACKGROUND

### 1. Technical Field

The present disclosure relates to a multi-feed detection device and an electronic device.

### 2. Related Art

Devices which handle a rectangular sheet-like medium are widely used, for example, printing devices which print a character or an image on a medium such as paper and electronic devices such as a scanner which reads an image printed on a medium. Such devices stock a plurality of media and transport the media one by one. When only one sheet of paper is extracted from the plurality of media and transported, a roller or the like having a surface on which rubber is installed is used.

Here, since the frictional resistance between the plurality of media varies due to the influence of humidity or the like, the plurality of media may be transported at the same time. Transport of the plurality of media is called multi-feed. JP-UM-A-5-56851 discloses a method of detecting multi-feed. According to JP-UM-A-5-56851, an ultrasonic transmitter and an ultrasonic receiver are installed in the device. The ultrasonic transmitter transmits an ultrasonic wave, and the ultrasonic receiver receives the ultrasonic wave.

A medium passes between the ultrasonic transmitter and the ultrasonic receiver. When the medium is irradiated with the ultrasonic wave, a portion of the ultrasonic wave reflects on the medium, and a portion of the ultrasonic wave is absorbed by the medium. Further, a portion of the ultrasonic wave passes through the medium. As the number of media increases, the ultrasonic wave is absorbed by the medium and thus an intensity of the ultrasonic wave passing through the medium decreases. Accordingly, by comparing the intensity of the ultrasonic wave received by the ultrasonic receiver with a determination value, it is possible to detect that a plurality of media are being passed through when the intensity of the ultrasonic wave is smaller than the determination value.

When an advancing direction of the ultrasonic wave transmitted from the ultrasonic transmitter is set in a thickness direction of the medium, the ultrasonic wave reflected on the medium returns to the ultrasonic transmitter. When the ultrasonic wave reciprocates between the ultrasonic transmitter and the medium, the ultrasonic wave transmitted from the ultrasonic transmitter and the reciprocating ultrasonic wave interfere with each other. Therefore, the intensity of the ultrasonic wave that the ultrasonic receiver receives fluctuates.

In order to suppress the ultrasonic wave from reciprocating between the ultrasonic transmitter and the medium, the advancing direction of the ultrasonic wave transmitted from the ultrasonic transmitter is set in a direction diagonally intersecting the thickness direction of the medium. The ultrasonic transmitter and the ultrasonic receiver are disposed on the same line. Here, a direction in which a line connecting the ultrasonic transmitter and the ultrasonic receiver extends diagonally intersects the surface of the medium. The ultrasonic transmitter and the ultrasonic receiver are fixed to a fixture, a member guiding the medium, or the like such that the advancing direction of the ultrasonic wave is diagonal to the advancing direction of the medium.

In order for the ultrasonic receiver to efficiently receive the ultrasonic wave transmitted from the ultrasonic transmitter, it is necessary to dispose the ultrasonic receiver within a range of the ultrasonic wave transmitted from the ultrasonic transmitter. However, an error with respect to the target position occurs in installation positions of the ultrasonic transmitter and the ultrasonic receiver. Furthermore, an error with respect to the target angle also occurs in the installation angle of the sound axis of the ultrasonic transmitter and the installation angle of the sound axis of the ultrasonic receiver. Since there is a need to have a process of accurately adjusting the position and the angle of the ultrasonic transmitter and the ultrasonic receiver, it was not easy to assemble a multi-feed detection device. Therefore, there has been a demand for a multi-feed detection device that can be easily assembled.

### SUMMARY

A multi-feed detection device according to an aspect of the present disclosure includes a substrate on which an ultrasonic transmitter transmitting an ultrasonic wave is installed, and an ultrasonic receiver having a receiving surface which receives the ultrasonic wave, in which the ultrasonic transmitter transmits the ultrasonic wave in a direction intersecting a thickness direction of the substrate, and an area of a cross-section of the ultrasonic wave cut along the receiving surface is wider than an area of the receiving surface.

In the multi-feed detection device, a plurality of ultrasonic receiving elements may be connected in parallel and disposed on the receiving surface.

An electronic device according to an aspect of the present disclosure includes a multi-feed detection device installed in a transport path of a medium and detecting whether or not two or more media are overlapped, in which the multi-feed detection device is the multi-feed detection device described above.

### BRIEF DESCRIPTION OF THE DRAWINGS

FIG. 1 is a schematic perspective diagram showing a configuration of a scanner according to a first embodiment.

FIG. 2 is a schematic side sectional diagram showing a structure of the scanner.

FIG. 3 is a schematic plan diagram showing the structure of the scanner.

FIG. 4 is a schematic side sectional diagram showing a configuration of a multi-feed detection device.

FIG. 5 is a schematic diagram for explaining an ultrasonic reception range of an ultrasonic receiver.

FIG. 6 is a schematic diagram for explaining an ultrasonic reception range of the ultrasonic receiver.

FIG. 7 is an electric circuit of the ultrasonic receiver configured of ultrasonic receiving elements.

FIG. 8 is an electrical block diagram showing a configuration of a control unit.

FIG. 9 is an electrical block diagram showing a configuration of the multi-feed detection device.

FIG. 10 is a flowchart of an assembly adjustment method.

FIG. 11 is a schematic diagram for explaining the assembly adjustment method.

FIG. 12 is a schematic diagram for explaining the assembly adjustment method.

FIG. 13 is a schematic diagram for explaining the assembly adjustment method.

FIG. 14 is a graph for explaining the assembly adjustment method.

FIG. 15 is a schematic side diagram showing a structure of a printing device according to a second embodiment.

### DESCRIPTION OF EXEMPLARY EMBODIMENTS

Hereinafter, embodiments will be described with reference to the drawings. In order to make each member in each drawing to be recognizable to each figure, the scale of each member is shown differently.

### First Embodiment

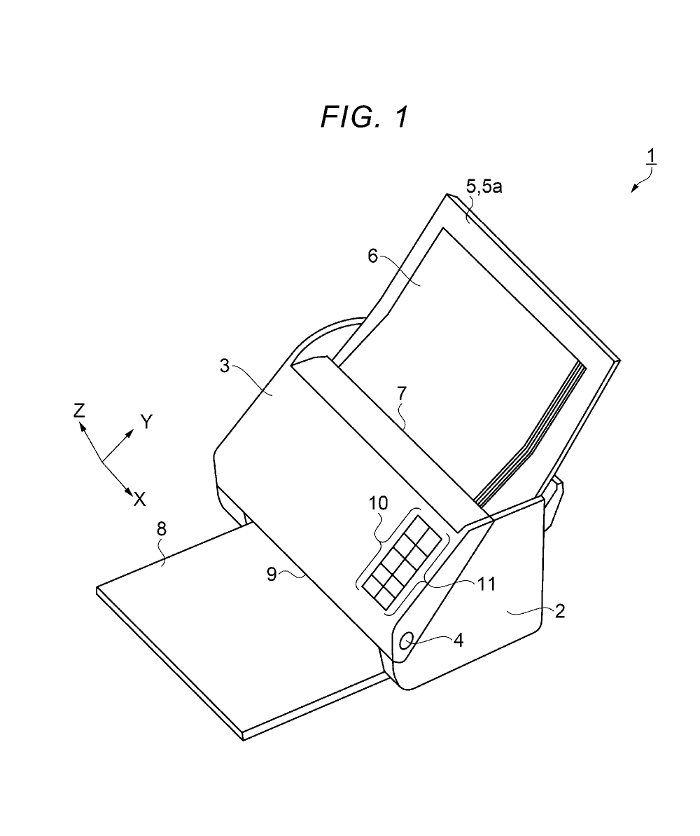

In the present embodiment, a characteristic example of a scanner including a multi-feed detection device will be described with reference to the drawings. The scanner according to the first embodiment will be described with reference to FIGS. 1 to 14. The scanner is a device which reads an image drawn on a medium, and also called an image reading device. FIG. 1 is a schematic perspective diagram showing a configuration of the scanner. As shown in FIG. 1, a scanner 1 as an electronic device includes a lower case 2 and an upper case 3. The lower case 2 and the upper case 3 are openably and closably coupled with each other by a hinge 4.

On a right upper side of the lower case 2 in FIG. 1, a cover portion 5 is pivotably attached to the lower case 2. A surface of the cover portion 5 on the upper case 3 side is a paper placing surface 5a. A plurality of sheets of paper 6 are placed as a medium on the paper placing surface 5a. The paper 6 has a rectangular shape, and the plurality of sheets of paper 6 have the same shape. A material of the paper 6 may be made of various types of resin material other than paper or synthetic paper. An opening feeding port 7 is disposed between the paper placing surface 5a and the upper case 3. The paper 6 is transported into the scanner 1 from the feeding port 7.

An advancing direction of the paper 6 is referred to as a −Y direction. A width direction of the paper 6 is referred to as an X direction. A direction in which the paper 6 is stacked is referred to as a Z direction. The X direction, a Y direction, and the Z direction are orthogonal to each other.

A paper discharge tray 8 is installed on the −Y direction side of the lower case 2. An opening discharge port 9 is disposed in the lower case 2 between the paper discharge tray 8 and the upper case 3. The paper 6 enters into the scanner 1 from the feeding port 7 and is discharged from the discharge port 9. The paper 6 discharged from the discharge port 9 is stacked on the paper discharge tray 8. In a path through which the paper 6 moves, the cover portion 5 side is referred to as upstream, and the paper discharge tray 8 side is referred to as downstream.

An indication lamp 10 and an instruction button 11 are disposed on a +X direction side of the upper case 3. The indication lamp 10 includes a light source such as a light emitting diode (LED). The indication lamp 10 can be turned on, blinked, and turned off. The indication lamp 10 notifies an operator of predetermined information, such as power on/off, currently selected mode, presence or absence of multi-feed detection, by turning on or off the indication lamp or by changing the color of the lamp.

The instruction button 11 includes a plurality of button-type switches for giving instructions to the scanner 1. The instruction button 11 is a switch for the operator to operate. Specifically, the instruction button 11 is configured of various switches such as a power switch, a start switch, a stop switch, a reading mode selection switch, and a switch for wireless communication.

The power switch is a switch for giving an instruction to switch supply and disconnection of power to the scanner 1. The start switch is a switch for giving an instruction to start transport of the paper 6. The stop switch is a switch for giving a stop instruction to interrupt or cancel a job started by the operation of the start switch. The reading mode selection switch is a switch for instructing a reading mode such as a color mode (for example, monochrome or color) and image quality. The switch for wireless communication is a switch for giving an instruction to switch on/off of the wireless communication.

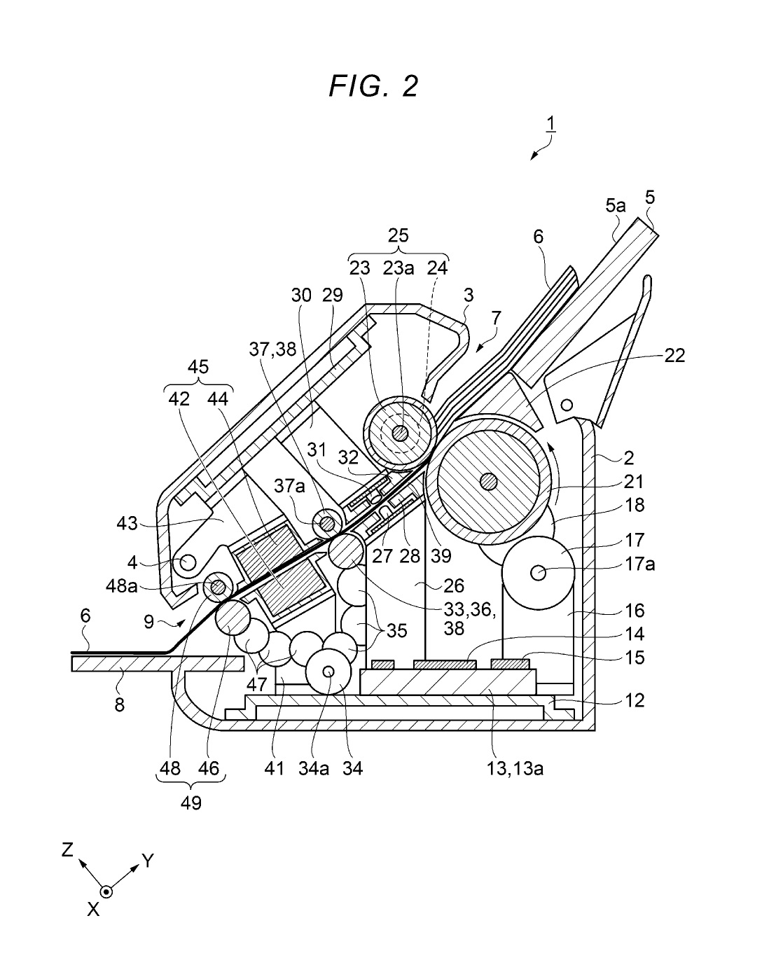

FIG. 2 is a schematic side sectional diagram showing a structure of the scanner. As shown in FIG. 2, a lower substrate 12 is installed at the bottom inside the lower case 2. The lower substrate 12 is a galvanized steel sheet having rigidity. A control unit 13 is installed on the lower substrate 12. The control unit 13 is configured of an electric circuit for controlling the operation of the scanner 1. The control unit 13 includes a circuit substrate 13a, and electric circuit elements such as a central processing unit 14 (CPU) and a memory 15 are installed on the circuit substrate 13a.

A feed motor 17 supported by a first support portion 16 is installed on the lower substrate 12. A first wheel train 18 and a feed roller 21 are disposed on a +Z direction side of the feed motor 17. A tooth form is formed on a rotation shaft 17a of the feed motor 17 and the first wheel train 18, respectively. A gear is installed in the feed roller 21.

When the feed motor 17 rotates the rotation shaft 17a, the torque generated by the feed motor 17 is transmitted to the feed roller 21 via the first wheel train 18. Thereby, the feed roller 21 rotates. An outer circumferential surface of the feed roller 21 is, for example, made of a high friction material such as an elastomer including rubber.

An upstream guide portion 22 is installed between the feed roller 21 and the cover portion 5. The upstream guide portion 22 is connected with the lower case 2. The paper 6 is placed on the upstream guide portion 22 and the cover portion 5. The upstream guide portion 22 and the cover portion 5 support the paper 6.

A separation roller 23 is installed on the +Z direction side of the feed roller 21. The separation roller 23 is disposed at a position facing the feed roller 21. The outer circumferential surface of the separation roller 23 is, like the feed roller 21, for example, made of a high friction material such as an elastomer including rubber.

The paper 6 placed on the upstream guide portion 22 moves in the −Y direction by the gravity acting on the paper 6. Then, an end of the paper 6 comes into contact with the separation roller 23. When the feed roller 21 is rotating in a counterclockwise direction in FIG. 2, the paper 6 being in contact with the upstream guide portion 22 enters between the feed roller 21 and the separation roller 23.

A shaft 23a of the separation roller 23 is biased by a spring (not shown). The separation roller 23 is pressed by the feed roller 21. A torque limiter 24 is installed on the shaft 23a. A separation mechanism 25 is configured of the separation roller 23 and the torque limiter 24.

When only one sheet of paper 6 is sandwiched between the feed roller 21 and the separation roller 23, the feed roller 21 and the separation roller 23 rotate together to transport the paper 6. A coil spring is installed in the torque limiter 24. As the shaft 23a rotates, the coil spring is bent to a predetermined angle to store a predetermined torque.

When two sheets of paper 6 are sandwiched between the feed roller 21 and the separation roller 23, the torque limiter 24 rotates the separation roller 23 by a predetermined angle in a direction different from the feed roller 21. Friction between the sheets of paper 6 is smaller than friction between the paper 6 and the feed roller 21, and is smaller than friction between the paper 6 and the separation roller 23. Accordingly, the overlapped paper 6 easily slide against each other. The feed roller 21 transports the paper 6 in the −Y direction, and the separation roller 23 moves the paper 6 in a +Y direction. Then, only one sheet of paper 6 is transported between the feed roller 21 and the separation roller 23. In this way, the separation mechanism 25 separates the overlapped paper 6. When three or more sheets of paper 6 are pinched between the feed roller 21 and the separation roller 23, the feed roller 21 may transport two or more sheets of paper 6.

A second support portion 26 is installed in the middle of the lower substrate 12 in FIG. 2, and an ultrasonic receiver 27 and a midstream lower guide portion 28 are installed on the second support portion 26. The ultrasonic receiver 27 is a device that receives an ultrasonic wave and converts the ultrasonic wave into an electrical signal. The midstream lower guide portion 28 guides the paper 6 passed through the feed roller 21.

An upper substrate 29 is installed on the +Z direction side inside the upper case 3. The upper substrate 29 is a galvanized steel sheet having rigidity. A third support portion 30 is installed in the middle of the upper substrate 29 in FIG. 2, and an ultrasonic transmitter 31 and a midstream upper guide portion 32 are installed on the third support portion 30. The ultrasonic transmitter 31 is a device which transmits an ultrasonic wave toward the ultrasonic receiver 27. The midstream upper guide portion 32 is disposed to face the midstream lower guide portion 28 and guides the paper 6 passed through the feed roller 21.

A transport drive roller 33 is installed on the −Y direction side of the midstream lower guide portion 28. A transport motor 34 for rotating the transport drive roller 33 is installed on the left side of the control unit 13 in FIG. 2. A second wheel train 35 is disposed between the transport drive roller 33 and the transport motor 34. A tooth form is formed on a rotation shaft 34a of the transport motor 34 and the gears of the second wheel train 35, respectively. A gear is installed in the transport drive roller 33.

When the transport motor 34 rotates the rotation shaft 34a, the torque generated by the transport motor 34 is transmitted to the transport drive roller 33 via the second wheel train 35. Thereby, the transport drive roller rotates. A transport encoder 36 is installed in the transport drive roller 33, and the transport encoder 36 detects a rotation angle of the transport drive roller 33.

A transport driven roller 37 is disposed to face the transport drive roller 33 on the +Z direction side of the transport drive roller 33. A shaft 37a of the transport driven roller 37 is biased to the transport drive roller 33 side by a spring (not shown). A pair of transport rollers 38 is configured of the transport drive roller 33 and the transport driven roller 37. The paper 6 passed between the midstream lower guide portion 28 and the midstream upper guide portion 32 is sandwiched between the pair of transport rollers 38 and transported in the −Y direction.

A fourth support portion 41 is installed on the lower substrate 12 on the left side of the second support portion 26 in FIG. 2. A lower reading unit 42 is installed on the fourth support portion 41. A fifth support portion 43 is installed on the upper substrate 29 on the −Y direction side of the third support portion 30. An upper reading unit 44 is installed on the fifth support portion 43. An image reading device 45 is configured of the lower reading unit 42, the upper reading unit 44, and the like. For example, a contact image sensor module (CISM) is installed in the lower reading unit 42 and the upper reading unit 44.

The hinge 4 is installed on the fifth support portion 43. The hinge 4 is also connected to a sixth support portion (not shown) installed on the lower substrate 12. The lower substrate 12 and the upper substrate 29 pivot about the hinge 4 as an axis. The scanner 1 includes a fixed portion (not shown) which pivotably fixes the lower case 2 and the upper case 3. The fixed portion can fix the upper case 3 and the lower case 2 in a state where the upper case 3 is closed.

A discharge drive roller 46 is installed on the −Y direction side of the lower reading unit 42. A third wheel train 47 is disposed between the discharge drive roller 46 and the transport motor 34. A tooth form is formed on each gear of the third wheel train 47. A gear is installed in the discharge drive roller 46.

When the transport motor 34 rotates the rotation shaft 34a, the torque generated by the transport motor 34 is transmitted to the discharge drive roller 46 via the third wheel train 47. Thereby, the discharge drive roller 46 rotates.

A discharge driven roller 48 is disposed to face the discharge drive roller 46 on the +Z direction side of the discharge drive roller 46. A shaft 48a of the discharge driven roller 48 is biased to the discharge drive roller 46 side by a spring (not shown). A pair of discharge rollers 49 are configured of the discharge drive roller 46 and the discharge driven roller 48. The paper 6 passed through the pair of discharge rollers 49 is transported on the paper discharge tray 8 from the discharge port 9. A path through which the paper 6 is passed between the cover portion 5 and the paper discharge tray 8 is a transport path 39.

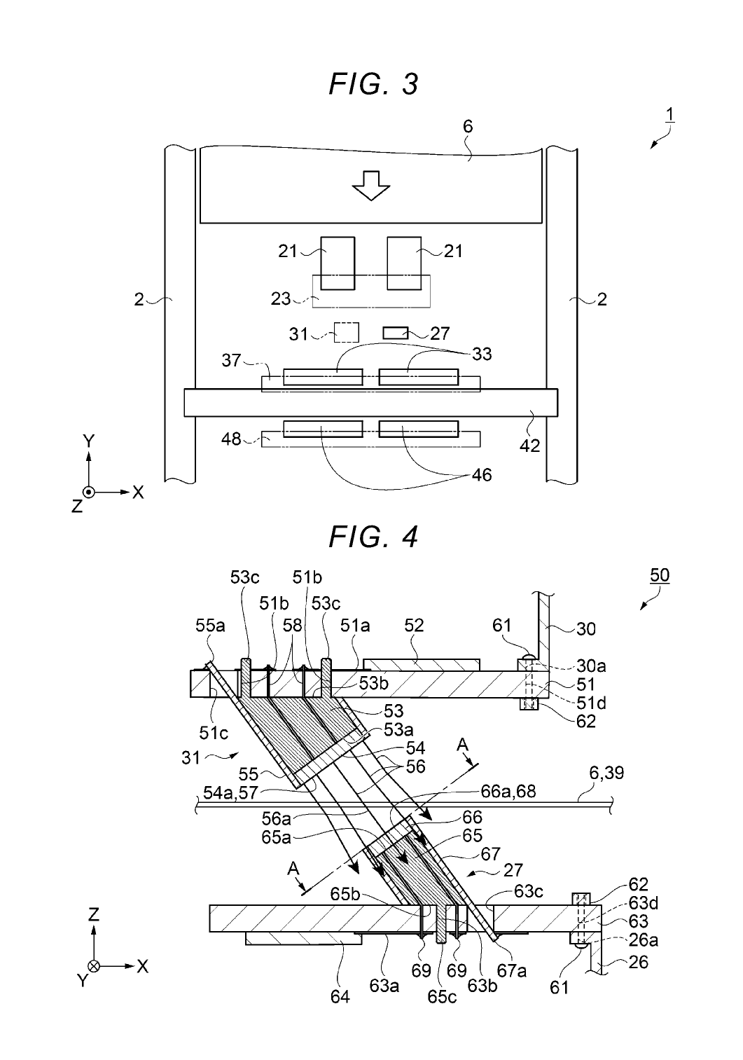

FIG. 3 is a schematic plan diagram showing a structure of the scanner, and a diagram of the scanner 1 seen from the Z side along the transport path 39 of the paper 6. As shown in FIG. 3, two of each feed roller 21, transport drive roller 33, and discharge drive roller 46 are disposed side by side in the X direction. The separation roller 23 is disposed to face two feed rollers 21. The transport driven roller 37 is disposed to face two transport drive rollers 33. The discharge driven roller 48 is disposed to face two discharge drive rollers 46. The ultrasonic receiver 27 is disposed on the +X direction side of the scanner 1, and the ultrasonic transmitter 31 is disposed on a −X direction side of the scanner 1.

FIG. 4 is a schematic side sectional diagram showing a structure of the multi-feed detection device, and is a diagram of the multi-feed detection device seen from the −Y direction side. As shown in FIG. 4, a multi-feed detection device 50 is installed in the transport path 39 of the paper 6. The multi-feed detection device 50 detects whether or not two or more sheets of paper 6 are overlapped. The multi-feed detection device 50 includes the ultrasonic receiver 27 and the ultrasonic transmitter 31. The multi-feed detection device 50 includes a transmission circuit substrate 51 as a substrate, and the ultrasonic transmitter transmitting an ultrasonic wave is installed on the transmission circuit substrate 51. In addition, a transmission drive circuit 52 for driving the ultrasonic transmitter 31 and a wiring 51a are also disposed on the transmission circuit substrate 51.

The ultrasonic transmitter 31 includes a transmission pedestal 53. The shape of the transmission pedestal 53 is not particularly limited, and it may be cylindrical, prismatic, rectangular parallelepiped, polyhedral, or the like. In the present embodiment, for example, the shape of the transmission pedestal 53 is cylindrical. The transmission pedestal 53 has a first surface 53a and a second surface 53b facing each other. The first surface 53a is a surface orthogonal to the cylindrical axis, and the second surface 53b is a surface intersecting the cylindrical axis. A transmission element substrate 54 is installed on the first surface 53a. The second surface 53b is fixed in contact with the transmission circuit substrate 51.

In the transmission pedestal 53, two cylindrical projection portions 53c are installed on the second surface 53b. Two through-holes 51b are installed on the transmission circuit substrate 51. Two projection portions 53c are inserted into two through-holes 51b, respectively. The transmission pedestal 53 is disposed on the transmission circuit substrate 51 with high positional accuracy by the projection portions 53c and the through-holes 51b.

A transmission shield 55 is installed on a side surface of the transmission pedestal 53. The shape of the transmission shield 55 is not particularly limited as long as it surrounds the transmission pedestal 53. The shape of the transmission shield 55 may be, for example, a cylindrical shape, a rectangular tube shape, a shape along a rectangular parallelepiped, a shape along a polyhedron, or the like. In the present embodiment, for example, the shape the transmission shield 55 is a cylindrical shape. The transmission shield 55 has a projection portion 55a installed on the transmission circuit substrate 51 side. A single through-hole 51c is installed on the transmission circuit substrate 51. The projection portion 55a is inserted into the through-hole 51c. The projection portion 55a is soldered to the wiring 51a. The transmission shield 55 is chassis grounded via the wiring 51a, and is shielded against static electricity and magnetic noise.

A surface of the transmission element substrate 54 facing the ultrasonic receiver 27 is referred to as a transmission surface 54a. Ultrasonic transmission elements 57 for transmitting an ultrasonic wave 56 are arranged in a matrix on the transmission surface 54a. Then, the ultrasonic wave 56 is transmitted in a spherical shape from each ultrasonic transmission element 57. The ultrasonic transmission elements 57 are arranged in a matrix in a rectangle, but the ultrasonic wave 56 advances in a cone shape as it goes away from the transmission element substrate 54. The advancing direction 56a of the ultrasonic wave is the direction of the conical rotation axis.

A rod-like drive wiring 58 is installed in the transmission pedestal 53. The drive wiring 58 is connected to each ultrasonic transmission element 57. The drive wiring 58 is electrically coupled to the transmission drive circuit 52 via the wiring 51a. The transmission drive circuit 52 supplies the drive voltage waveform to the ultrasonic transmission element 57 via the wiring 51a and the drive wiring 58. The ultrasonic transmission element vibrates according to the drive voltage waveform and transmits the ultrasonic wave 56. A flexible printed circuit (FPC) may be used instead of the rod-like drive wiring 58.

Furthermore, the transmission circuit substrate 51 includes a through-hole 51d. A through-hole 30a is also installed on the third support portion 30. A screw 61 is inserted into the through-hole 51d and the through-hole 30a and is fixed by a nut 62.

The multi-feed detection device 50 includes a receiving circuit substrate 63, and the ultrasonic receiver 27 for receiving the ultrasonic wave 56 is installed on the receiving circuit substrate 63. In addition, a receiving drive circuit 64 for driving the ultrasonic receiver 27 and a wiring 63a are disposed on the receiving circuit substrate 63.

The ultrasonic receiver 27 includes a receiving pedestal 65. The shape of the receiving pedestal 65 is not particularly limited, and it may be cylindrical, prismatic, rectangular parallelepiped, or polyhedral. In the present embodiment, for example, the shape of the receiving pedestal 65 is cylindrical. The receiving pedestal 65 has a first surface 65a and a second surface 65b facing each other. The first surface 65a is a surface orthogonal to the cylindrical axis, and the second surface 65b is a surface intersecting the cylindrical axis. A receiving element substrate 66 is installed on the first surface 65a. The second surface 65b is fixed in contact with the receiving circuit substrate 63.

Two cylindrical projection portions 65c are installed side by side in the Y direction on the second surface 65b of the receiving pedestal 65. Two through-holes 63b are installed side by side in the Y direction on the receiving circuit substrate 63. Two projection portions 65c are inserted into two through-holes 63b, respectively. The receiving pedestal 65 is disposed on the receiving circuit substrate 63 with high positional accuracy by the projection portions 65c and the through-holes 63b.

A receiving shield 67 is installed on a side surface of the receiving pedestal 65. The shape of the receiving shield 67 is not particularly limited as long as it surrounds the receiving pedestal 65. The shape of the receiving shield 67 may be, for example, a cylindrical shape, a rectangular tube shape, a shape along a rectangular parallelepiped, a shape along a polyhedron, or the like. In the present embodiment, for example, the shape of the receiving shield 67 is a cylindrical shape. The receiving shield 67 has a projection portion 67a installed on the receiving circuit substrate 63 side. One through-hole 63c is installed on the receiving circuit substrate 63. The projection portion 67a is inserted into the through-hole 63c. The projection portion 67a is soldered to the wiring 63a. The receiving shield 67 is chassis grounded via the wiring 63a, and is shielded against static electricity and magnetic noise.

A surface of the receiving element substrate 66 facing the ultrasonic transmitter 31 is referred to as a receiving surface 66a. The receiving surface 66a is a surface on which the ultrasonic receiver 27 receives the ultrasonic wave 56. Ultrasonic receiving elements 68 for receiving the ultrasonic wave 56 are arranged in a matrix on the receiving surface 66a. Each ultrasonic receiving element 68 receives the ultrasonic wave 56.

A rod-like output wiring 69 is installed in the receiving pedestal 65. The output wiring 69 is connected to each ultrasonic receiving element 68. The output wiring 69 is electrically coupled to the receiving drive circuit via the wiring 63a. The receiving drive circuit 64 receives the reception voltage waveform output from the ultrasonic receiving element 68 via the wiring 63a and the output wiring 69. An FPC may be used instead of the rod-like output wiring 69.

The receiving circuit substrate 63 includes a through-hole 63d. A through-hole 26a is also installed on the second support portion 26. The screw 61 is inserted into the through-hole 63d and the through-hole 26a and are fixed by the nut 62.

The paper 6 is transported between the ultrasonic receiver 27 and the ultrasonic transmitter 31. The ultrasonic transmitter 31 transmits the ultrasonic wave 56 in a direction intersecting a thickness direction of the transmission circuit substrate 51. Thereby, the ultrasonic receiver 27 receives the ultrasonic wave 56 passed through the paper 6.

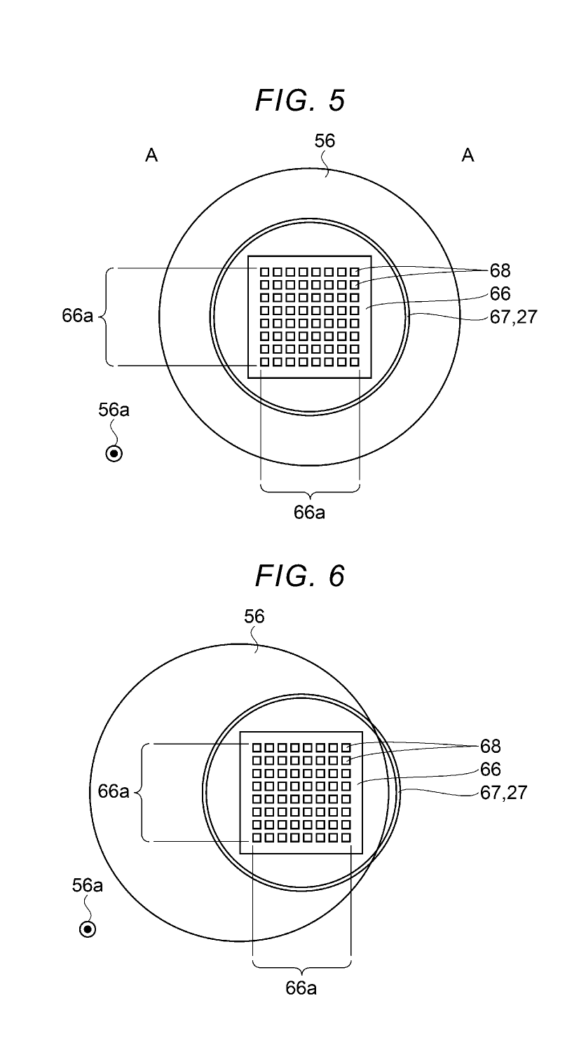

FIGS. 5 and 6 are schematic diagrams for explaining an ultrasonic reception range of an ultrasonic receiver, and a diagram as seen from a side of a surface along line A-A of FIG. 4. As shown in FIG. 5, the ultrasonic receiving elements 68 are arranged in a matrix on the receiving element substrate 66. The range of the receiving surface 66a is referred to as a range on which the ultrasonic receiving elements 68 are arranged. An area of a cross-section of the ultrasonic wave 56 cut along the receiving surface 66a is wider than an area of the receiving surface 66a. For visibility of FIG. 5, eight rows and eight columns of ultrasonic receiving elements 68 are arranged on the receiving element substrate 66. The number of ultrasonic receiving elements 68 installed on the receiving element substrate 66 is not particularly limited. For example, in the present embodiment, 100 ultrasonic receiving elements 68 of 10 rows and 10 columns are arranged on the receiving element substrate 66. For example, in the present embodiment, 900 ultrasonic transmission elements 57 of 30 rows and 30 columns are arranged on the transmission element substrate 54.

As shown in FIG. 6, when the position or the direction at which the ultrasonic transmitter 31 transmits the ultrasonic wave 56 is shifted with respect to the ultrasonic receiver 27, the center of the ultrasonic wave 56 seen from the advancing direction 56a of the ultrasonic wave 56 is shifted from the center of the receiving surface 66a. However, the area of the cross-section of the ultrasonic wave 56 cut along the receiving surface 66a is wider than the area of the receiving surface 66a. Here, the ultrasonic wave 56 applied to the receiving surface 66a is wider than the receiving surface 66a. Thereby, the relative position between the transmission circuit substrate 51 and the ultrasonic receiver 27 can be easily adjusted so that the receiving surface 66a can receive the ultrasonic wave 56. As a result, the multi-feed detection device 50 can be easily assembled.

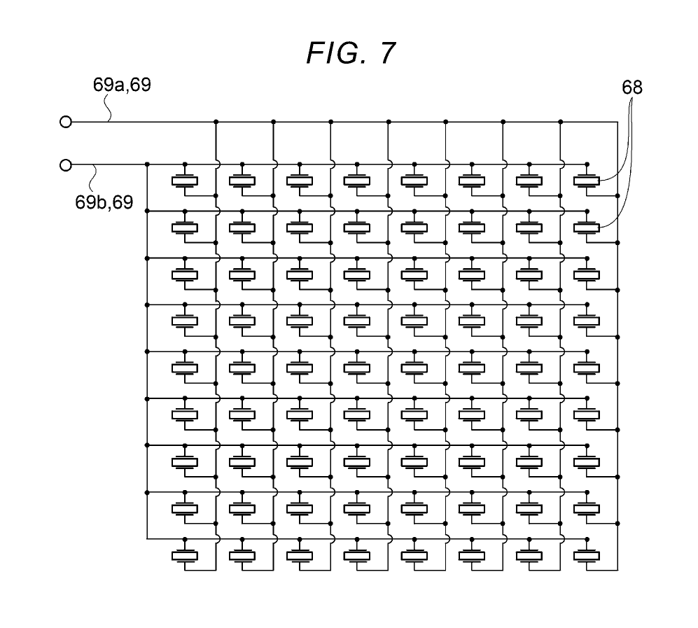

FIG. 7 is an electric circuit of the ultrasonic receiver configured of the ultrasonic receiving elements. As shown in FIG. 7, the ultrasonic receiving elements 68 arranged in a matrix have two electrodes. One of the electrodes is connected to a first wiring 69a, and the other electrode is connected to a second wiring 69b. That is, a plurality of ultrasonic receiving elements 68 are connected in parallel and disposed on the receiving surface 66a. Here, since the plurality of ultrasonic receiving elements 68 are electrically coupled to a common output wiring 69, the wiring structure can be simplified. Accordingly, the portion of the output wiring 69 occupying the receiving surface 66a is reduced so that the ultrasonic receiver 27 can efficiently receive the ultrasonic wave 56.

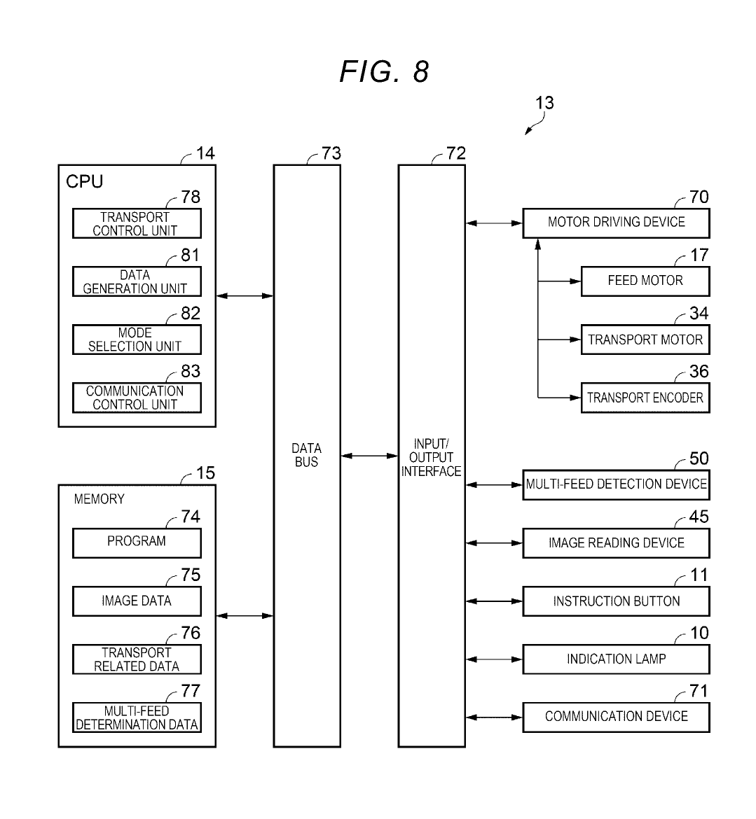

FIG. 8 is an electrical block diagram showing a configuration of a control unit. In FIG. 8, the control unit 13 includes the CPU 14 (central processing unit) for performing various arithmetic processing as a processor and the memory 15 for storing various information. A motor driving device 70, the multi-feed detection device 50, the image reading device 45, the instruction button 11, the indication lamp 10, and a communication device 71 are connected to the CPU 14 via an input/output interface 72 and a data bus 73.

The motor driving device 70 is a circuit for driving the feed motor 17, the transport motor 34, and the transport encoder 36. The motor driving device 70 receives an instruction signal of the CPU 14. The motor driving device 70 rotates the feed motor 17 and the transport motor at a predetermined rotation angle at a predetermined rotation speed according to the instruction signal. The paper 6 is moved by the rotation of the feed motor 17 and the transport motor 34.

The motor driving device 70 converts the signal output from the transport encoder 36 into digital data and outputs the digital data to the CPU 14. Since the transport encoder 36 detects a moving amount of the paper 6, the CPU 14 receives the signal output from the motor driving device 70 and recognizes the position of the paper 6.

The multi-feed detection device 50 is a device installed in the transport path 39 of the paper 6 and a device which detects whether or not two or more sheets of paper 6 are overlapped. The multi-feed detection device 50 compares the intensity of the ultrasonic wave 56 received by the ultrasonic receiver 27 with a determination value to detect the multi-feed of the paper 6. The multi-feed detection device 50 outputs information indicating a multi-feed state to the CPU 14 when two or more sheets of paper 6 are transported in the transport path 39 in an overlapped manner.

The image reading device 45 is a device which reads images on front and back surfaces of the paper 6. The image reading device 45 controls the lower reading unit 42 and the upper reading unit 44 while transporting the paper 6, and reads an image on the paper 6. Specifically, the image reading device 45 outputs a pulse signal for controlling the operation timing of a reading operation of a pixel signal with respect to the contact image sensor module and the like and controls the reading operation. The analog pixel signal output from the contact image sensor module is converted into digital image data and is stored in the memory 15. The image data includes information on the density of pixels constituting the image.

The instruction button 11 includes a plurality of switches and output information indicating the switch operated by the operator to the CPU 14. The indication lamp 10 includes a plurality of light sources. The indication lamp 10 receives the instruction signal of the CPU 14. Then, the light source corresponding to the instruction signal is turned on, blinked, or turned off.

The communication device 71 is a device which communicates with an external device. The communication device 71 communicates with the external device and outputs data of the image information read from the paper 6 to the external device according to a communication protocol. The communication device 71 inputs various data and a reading start signal used at the time of reading an image.

The memory 15 is a concept including a semiconductor memory such as RAM, and ROM, and an external storage device such as a hard disk. The memory 15 stores a program 74 on which a control procedure of the operation of the scanner 1 and the like are written. The memory 15 stores image data 75 which is data of an image read by the image reading device 45. The memory 15 stores transport related data 76 which is data of various parameters used when the CPU 14 transports the paper 6. The memory 15 stores multi-feed determination data 77 which is data such as a determination value used when the multi-feed detection device 50 determines whether or not the paper is in a multi-feed state. The memory 15 includes a storage area functioning as a work area for the CPU 14, a temporary file, or the like, and other various storage areas.

The CPU 14 controls the operation of the scanner 1 according to the program 74 stored in the memory 15. The CPU 14 has various functional units for realizing functions. The CPU 14 has a transport control unit 78 as a specific functional unit. The transport control unit 78 controls a moving speed, the moving amount, a moving position, and the like of the paper 6. The transport control unit 78 outputs a parameter for controlling the transport of the paper 6 to the motor driving device 70. The transport control unit 78 outputs an instruction signal for starting and stopping the transport of the paper 6 to the motor driving device 70. The motor driving device 70 transports the paper 6 to the feed roller 21, the pair of transport rollers 38, and the pair of discharge rollers 49 according to the instruction signal output from the transport control unit 78.

The CPU 14 has a data generation unit 81. The data generation unit 81 performs correction processing such as shading correction and gamma correction with respect to the received digital image data 75, and generates the image data 75 for the output of paper 6.

The CPU 14 has a mode selection unit 82. The instruction button 11 includes one multi-feed detection switching switch. The mode selection unit 82 sets, for example, either an enable mode which enables multi-feed detection or a disable mode which disables the multi-feed detection of the multi-feed detection device 50 according to the instruction from the multi-feed detection switching switch.

The CPU 14 has a communication control unit 83. The communication control unit 83 communicates with an external device via the communication device 71. The communication control unit 83 receives an instruction signal from an external device and starts an operation such as reading. The communication control unit 83 converts the image data 75 into a data format to be communicated, and outputs the converted data to the communication device 71. The image data 75 is transmitted to the external device via the communication device 71.

The CPU 14 has a functional unit (not shown). For example, the CPU 14 performs control to display information related to device status display or reading on the indication lamp 10. The CPU 14 performs control to notify abnormality with the indication lamp 10 when the abnormality occurs in the scanner 1.

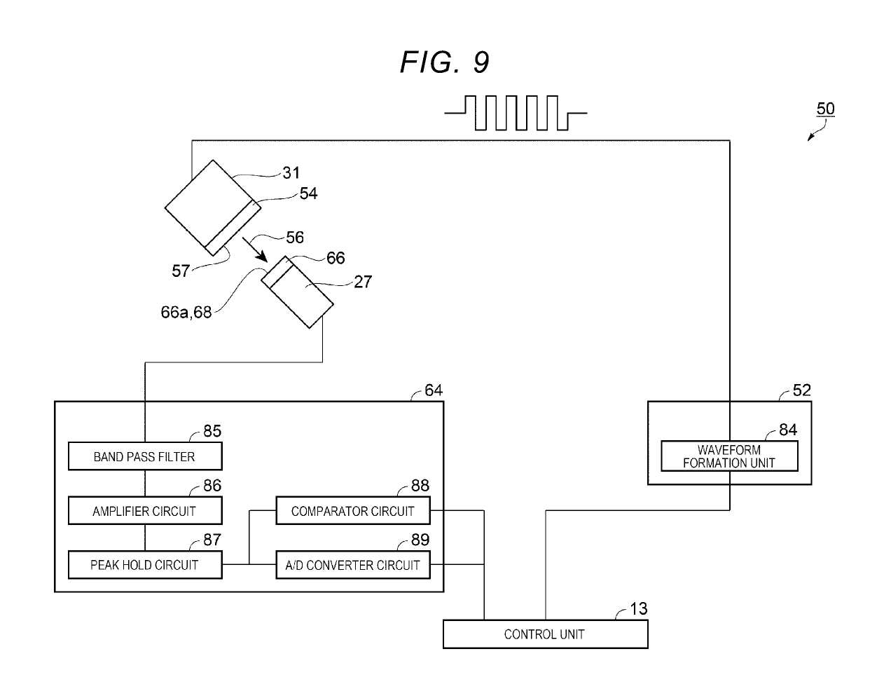

FIG. 9 is an electrical block diagram showing a configuration of the multi-feed detection device. As shown in FIG. 9, the transmission drive circuit 52 is electrically connected to the control unit 13. The transmission drive circuit 52 includes a waveform formation unit 84. In the transmission drive circuit 52, the waveform formation unit forms a drive waveform for driving and outputs the waveform to the ultrasonic transmission element 57. The drive waveform is a waveform matching the characteristics of the ultrasonic transmission elements 57, and is not particularly limited. In the present embodiment, the drive waveform is, for example, a burst wave having a voltage amplitude of 24 V and a frequency of 300 KHz. The ultrasonic transmission element 57 receives the drive waveform and transmits the ultrasonic wave 56.

The ultrasonic receiving element 68 installed on the receiving surface 66a of the receiving element substrate 66 receives the ultrasonic wave 56 and outputs the voltage waveform to the receiving drive circuit 64. The receiving drive circuit 64 includes a band pass filter 85, and the band pass filter 85 receives the voltage waveform from the ultrasonic receiving element 68. The center frequency of the band pass filter 85 is 300 KHz, and the band pass filter 85 has a function of removing noise components other than the waveform corresponding to the ultrasonic wave 56 from the voltage waveform.

An amplifier circuit 86 is disposed in electrical connection with the band pass filter 85. The amplifier circuit 86 amplifies the voltage waveform received from the band pass filter 85 to substantially 10,000 times. As the amplifier circuit 86 amplifies the voltage waveform, the influence of noise decreases. A peak hold circuit 87 is disposed in electrical connection with the amplifier circuit 86. The peak hold circuit 87 detects the maximum amplitude of the burst signal of the voltage waveform.

A comparator circuit 88 and an analog-to-digital converter 89 (A/D converter circuit) are disposed in electrical connection with the peak hold circuit 87. The comparator circuit 88 compares the multi-feed determination data 77 stored in the memory 15 with the maximum amplitude of the burst signal. Then, the determination result is output to the control unit 13. When the paper is multi-fed, the CPU 14 notifies the operator that multi-feed has occurred by blinking one indication lamp 10.

The A/D converter circuit 89 converts the maximum amplitude of the burst signal into digital data. The maximum amplitude of the burst signal converted into digital data is output to the CPU 14. The maximum amplitude of the burst signal changes when the medium transported through the transport path 39 is changed from the paper 6. The operator can reset the multi-feed determination data 77 of the predetermined medium with reference to the maximum amplitude of the burst signal. Accordingly, the multi-feed detection device 50 can determine multi-feed even when the paper 6 is replaced with another medium.

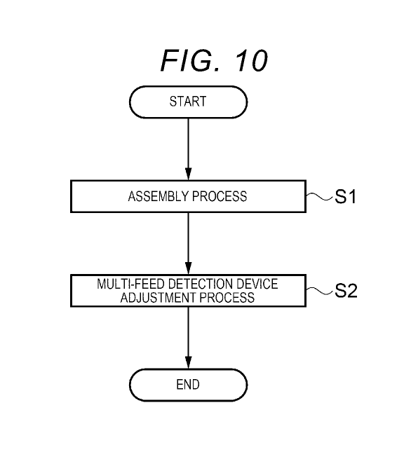

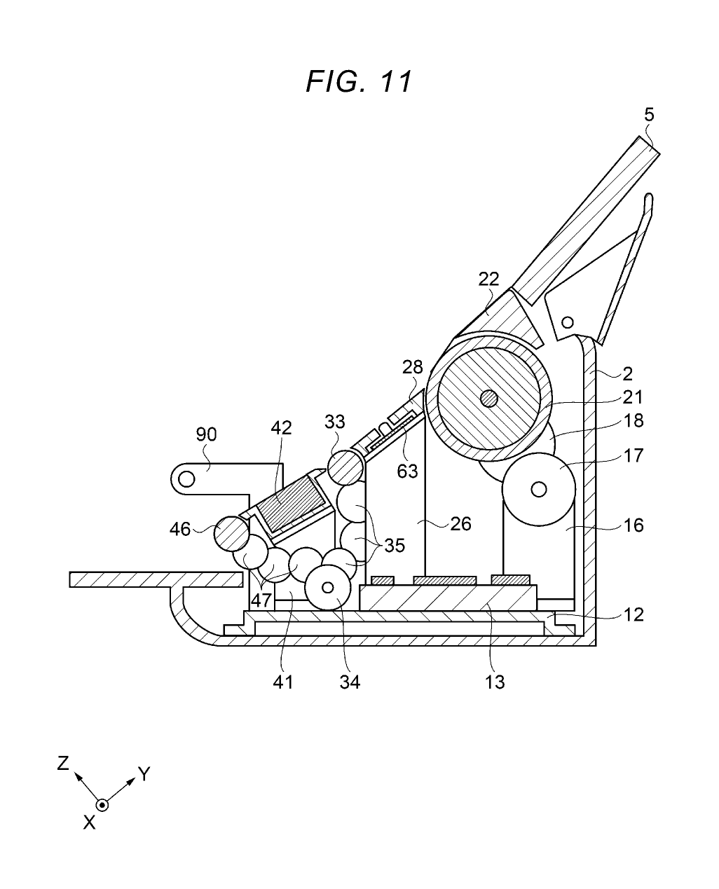

Next, the assembly adjustment method of the above-described scanner 1 will be described with reference to FIGS. 10 to 14. FIG. 10 is a flowchart of the assembly adjustment method. FIGS. 11 to 14 are diagrams for explaining the assembly adjustment method. In the flowchart of FIG. 10, step S1 is an assembly process. This process is a process of assembling the scanner 1. Next, the procedure proceeds to step S2. Step S2 is a multi-feed detection device adjustment process. This process is a process of adjusting the positional deviation of the multi-feed detection device 50. The assembly adjustment process is ended in the above steps.

Next, the assembly adjustment method will be described in detail in correspondence with steps shown in FIG. 10 using FIG. 2 and FIGS. 11 to 14.

FIGS. 2, 11, and 12 are diagrams corresponding to the assembly process of step S1. As shown in FIG. 11, the lower substrate 12 is fixed on the bottom surface inside the lower case 2 with screws. Next, the transport motor 34 and the control unit 13 are fixed on the lower substrate 12 with screws.

Next, the lower reading unit 42 is fixed to the fourth support portion 41 with screws. Then, the fourth support portion 41 is fixed to the lower substrate 12 with screws. Next, the receiving circuit substrate 63 and the midstream lower guide portion 28 are fixed to the second support portion 26 with screws. Then, the second support portion 26 is fixed to the lower substrate 12 with screws. Next, the feed motor 17 is fixed to the first support portion 16 with screws. Then, the first support portion 16 is fixed to the lower substrate 12 with screws. Next, the sixth support portion 90 supporting the hinge 4 is fixed to the lower substrate 12 with screws.

Next, a lower plate (not shown) is temporarily installed on the lower substrate 12. The lower plate is installed on the +X direction side and the −X direction side of the lower substrate 12. Bearings of the discharge drive roller 46, the third wheel train 47, the transport drive roller 33, the second wheel train 35, the first wheel train 18, and the feed roller 21 are installed on the lower plate. Next, the discharge drive roller 46, the third wheel train 47, the transport drive roller 33, the second wheel train 35, the first wheel train 18, and the feed roller 21 are installed on each bearing on the lower plate. Next, the lower plate is fixed to the lower substrate 12 with screws. Next, the cover portion 5, the upstream guide portion 22, and the like are installed on the lower case 2.

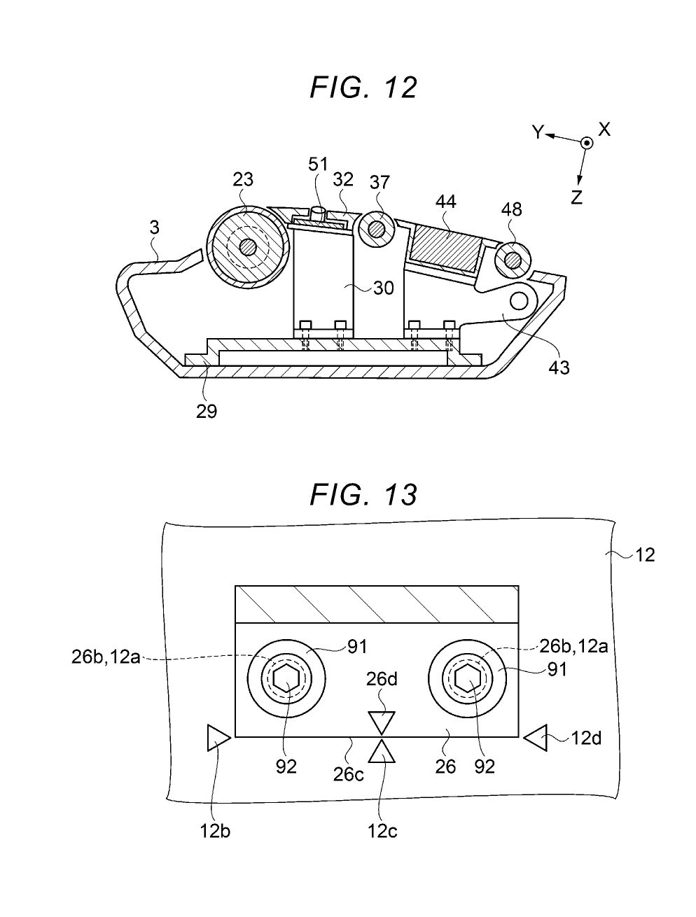

As shown in FIG. 12, the upper substrate 29 is fixed on the bottom surface inside the upper case 3 with screws. Next, the upper reading unit 44 is fixed to the fifth support portion 43 with screws. Then, the fifth support portion 43 is fixed to the upper substrate 29 with screws. Next, the transmission circuit substrate 51 and the midstream upper guide portion 32 are fixed to the third support portion 30 with screws. Then, the third support portion 30 is fixed to the upper substrate 29 with screws.

Next, an upper plate (not shown) is temporarily installed on the upper substrate 29. The upper plate is installed on the +X direction side and the −X direction side of the upper substrate 29. Bearings of the separation roller 23, the transport driven roller 37, and the discharge driven roller 48 are installed on the upper plate. Next, the separation roller 23, the transport driven roller 37, and the discharge driven roller 48 are installed on each bearing on the upper plate. Next, the upper plate is fixed to the upper substrate 29 with screws. Next, the fifth support portion 43 and the sixth support portion 90 are rotatably fixed to the hinge 4 with screws. As a result, the scanner 1 shown in FIG. 2 is assembled.

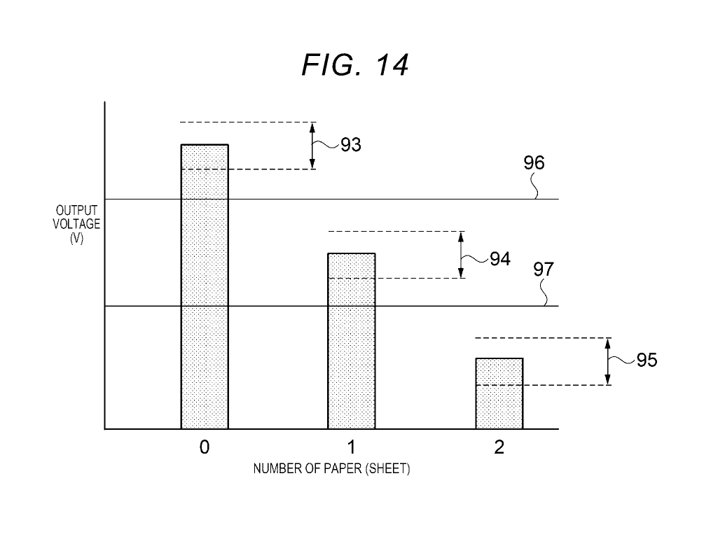

FIGS. 13 and 14 are diagrams corresponding to the multi-feed detection device adjustment process of step S2. As shown in FIG. 13, two through-holes 26b are disposed in the second support portion 26. A female screw 12a is formed in the lower substrate 12 at a position facing each through-hole 26b. A washers 91 is disposed on the second support portion 26, and a bolt 92 is inserted into each washer 91 and the through-hole 26b. A male screw of the bolt 92 is screwed to each female screw 12a of the lower substrate 12.

A diameter of the through-hole 26b is larger than the diameter of a cylindrical portion of the bolt 92. The second support portion 26 can be moved by the length of the difference between the diameter of the through-hole 26b and the diameter of the cylindrical portion of the bolt 92.

A first mark 12b, a second mark 12c, and a third mark 12d are disposed on the lower substrate 12. An end surface 26c of the second support portion 26 is positioned between the first mark 12b and the third mark 12d. A mark 26d is installed on the second support portion 26 at a position facing the second mark 12c.

When the operator moves the second support portion 26 to the right and left of FIG. 13, the position of the mark 26d is shifted with respect to the second mark 12c. The operator can check the position of the second support portion 26 in the horizontal direction of FIG. 13 with respect to the lower substrate 12 by checking the position of the mark 26d with respect to the second mark 12c. When the operator moves the second support portion 26 to the up and down of FIG. 13, the position of the end surface 26c is shifted with respect to the first mark 12b and the third mark 12d. The operator can check the position of the second support portion 26 in the vertical direction of FIG. 13 with respect to the lower substrate 12 by checking the position of the end surface 26c with respect to the first mark 12b and the third mark 12d. Accordingly, the operator can adjust the position while checking the position of the second support portion 26 with respect to the lower substrate 12.

FIG. 14 is a graph for explaining the output voltage of the peak hold circuit in each number of paper 6. In FIG. 14, a vertical axis shows the output voltage of the peak hold circuit 87. A horizontal axis shows the number of paper 6 passing through the ultrasonic transmitter 31. When the number of paper 6 is zero, that is, when there is no paper 6 between the ultrasonic receiver 27 and the ultrasonic transmitter 31, the output voltage of the peak hold circuit 87 is high. When the number of paper 6 increases, the output voltage decreases.

A first setting range 93 which is a setting range of the output voltage when the number of paper 6 is zero is set. As shown in FIGS. 5 and 6, when the receiving surface 66a is within the irradiation range of the ultrasonic wave 56, the output voltage of the peak hold circuit 87 falls within the first setting range 93. The area of the cross-section of the ultrasonic wave 56 cut along the receiving surface 66a is wider than the area of the receiving surface 66a. Therefore, the relative position between the transmission circuit substrate 51 and the ultrasonic receiver 27 can be easily adjusted so that the receiving surface 66a can receive the ultrasonic wave 56.

The relative position between the transmission circuit substrate 51 and the ultrasonic receiver 27 is adjusted so that the output voltage of the peak hold circuit falls within the first setting range 93. Here, the operator loosens the bolt 92 and adjusts the position of the second support portion 26 with respect to the lower substrate 12 while checking the output voltage of the peak hold circuit 87 as shown in FIG. 13. Returning to FIG. 14, the output voltage of the peak hold circuit 87 when the number of paper 6 is one falls within a first voltage range 94. The output voltage of the peak hold circuit 87 when the number of paper 6 is two falls within a second voltage range 95.

The intermediate voltage between the lower limit voltage of the first setting range 93 and the upper limit voltage of the first voltage range 94 is referred to as a presence determination voltage 96. The comparator circuit 88 compares the output voltage of the peak hold circuit 87 with the presence determination voltage 96. When the output voltage of the peak hold circuit 87 is higher than the presence determination voltage 96, the comparator circuit 88 outputs a signal indicating that there is no paper 6 between the ultrasonic receiver 27 and the ultrasonic transmitter 31 to the control unit 13.

The intermediate voltage between the lower limit voltage of the first voltage range 94 and the upper limit voltage of the second voltage range 95 is referred to as a multi-feed determination voltage 97. The comparator circuit 88 compares the output voltage of the peak hold circuit 87 with the multi-feed determination voltage 97. When the output voltage of the peak hold circuit 87 is lower than the multi-feed determination voltage 97, the comparator circuit 88 outputs a signal indicating that there are two or more sheets of paper 6 between the ultrasonic receiver 27 and the ultrasonic transmitter 31 to the control unit 13.

In this way, by adjusting the relative position between the transmission circuit substrate 51 and the ultrasonic receiver 27 so that the output voltage of the peak hold circuit 87 falls within the first setting range 93, it is easy to detect whether the number of paper 6 between the transmission circuit substrate 51 and the ultrasonic receiver 27 is zero or two or more. The relative position between the transmission circuit substrate 51 and the ultrasonic receiver 27 is adjusted and the bolt 92 is fixed when the output voltage of the peak hold circuit 87 falls within the first setting range 93. The multi-feed detection device adjustment process of step S2 ends.

As described above, according to the present embodiment, it has the following effects.

(1) According to the present embodiment, the multi-feed detection device 50 includes the transmission circuit substrate 51 on which the ultrasonic transmitter 31 is installed and the ultrasonic receiver 27. The ultrasonic receiver 27 receives the ultrasonic wave 56 transmitted from the ultrasonic transmitter 31. When the paper 6 is present in the course of the ultrasonic wave 56, as the number of paper 6 increases, the intensity of the ultrasonic wave 56 passing through the paper 6 decreases, so that the multi-feed detection device 50 can detect the number of paper 6.

The ultrasonic transmitter 31 transmits the ultrasonic wave 56 in a direction intersecting a thickness direction of the transmission circuit substrate 51. When advancing the paper 6 in a planar direction of the transmission circuit substrate 51, the reflected wave of the ultrasonic wave 56 reflected on the paper 6 advances in a direction different from the direction of the ultrasonic transmitter 31. Accordingly, it is possible to suppress the ultrasonic wave 56 transmitted from the ultrasonic transmitter 31 interfering with the reflected wave.

The ultrasonic receiver 27 receives the ultrasonic wave 56 on the receiving surface 66a. The area of the cross-section of the ultrasonic wave 56 cut along the receiving surface 66a is wider than the area of the receiving surface 66a. Here, the ultrasonic wave 56 applied to the receiving surface 66a is wider than the receiving surface 66a. Thereby, the relative position between the transmission circuit substrate 51 and the ultrasonic receiver 27 can be easily adjusted so that the receiving surface 66a can receive the ultrasonic wave 56. As a result, the operator can easily assemble the multi-feed detection device 50.

(2) According to the present embodiment, a plurality of ultrasonic receiving elements 68 are connected in parallel on the receiving surface 66a. Here, since the plurality of ultrasonic receiving elements 68 are electrically connected with a common wiring, the wiring structure can be simplified. Since the portion of the wiring occupying the receiving surface 66a is reduced, the ultrasonic receiver 27 can efficiently receive the ultrasonic wave 56.

(3) According to the present embodiment, the scanner 1 includes the transport path 39. The multi-feed detection device 50 is installed in the transport path 39, and the multi-feed detection device 50 detects whether or not two or more sheets of paper 6 are overlapped. The multi-feed detection device 50 is a device that can be easily assembled. Accordingly, the scanner 1 can be a device including the multi-feed detection device 50 with good assembly.

### Second Embodiment

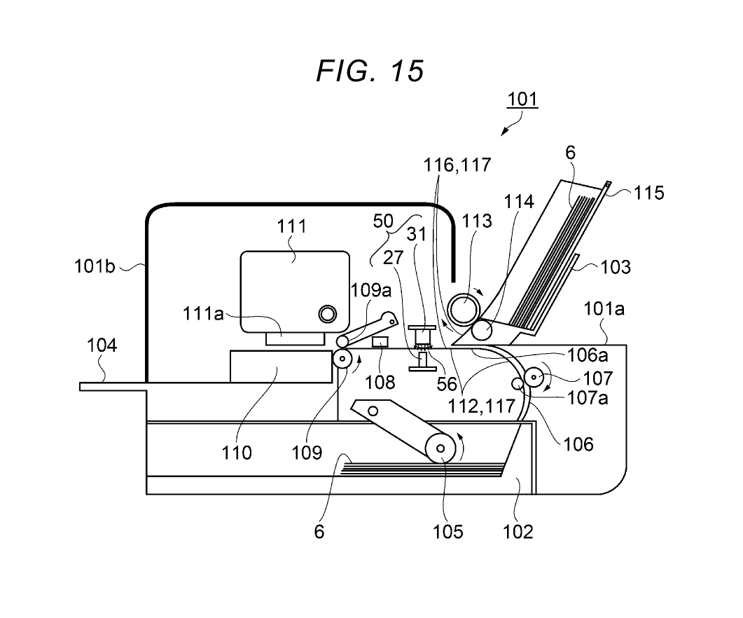

Next, an embodiment of a printing device including a multi-feed detection device 50 will be described using a schematic side diagram showing a structure of a printing device of FIG. 15. The description on the same point as in the first embodiment will be omitted.

That is, in the present embodiment, as shown in FIG. 15, a printer 101 as an electronic device has a front paper feed tray 102 and a rear paper feed tray 103. The front paper feed tray 102 is installed substantially horizontally on a bottom portion of the printer 101. The rear paper feed tray 103 is disposed on a rear surface 101a of the printer 101 so as to protrude to the upper right in FIG. 15. Various types of paper 6 can be placed on the front paper feed tray 102 and the rear paper feed tray 103.

The paper 6 placed on the front paper feed tray 102 and the rear paper feed tray 103 is supplied through a predetermined transport path. The paper 6 is transported along the transport path and is discharged to a paper discharge tray 104 disposed on a front surface 101b side of the printer 101. That is, in the printer 101, there are a first transport path 112 of the paper 6 with the front paper feed tray 102 at an upstream position of the transport path, and a second transport path 116 of the paper 6 with the rear paper feed tray 103 at the upstream position of the transport path.

First, transport of the paper 6 from the first transport path 112 will be described. A pickup roller 105 is provided so that the outer circumference of the pickup roller 105 comes into contact with the paper 6 with respect to the uppermost paper 6 among the paper 6 placed on the front paper feed tray 102 in FIG. 15. The pickup roller 105 is joined with a transport motor, a gear, and the like (not shown). The pickup roller 105 is rotated about a rotation axis parallel to the paper 6 by the driving of the transport motor.

The pickup roller 105 rotates in the counterclockwise direction in FIG. 15 and sends out the paper 6 which comes into contact with the outer circumference of the pickup roller 105 to the rear surface 101a side. Then, an end of the paper 6 on the right side of FIG. 15 is guided to a transport guide 106. A portion of the transport guide 106 forms the transport path curved so as to draw a substantially semicircle. The paper 6 is guided to the transport guide 106 and advances to the paper discharge tray 104 side. The paper 6 is supplied to the upper side of FIG. 15 while being bent along the transport guide 106. An intermediate roller 107 is provided in the middle of the curved path of the transport guide 106. The outer circumference of the intermediate roller 107 is in contact with the paper 6 of the transport guide 106 from the right side in FIG. 15, and the intermediate roller 107 rotates about a rotation axis parallel to the paper 6. The intermediate roller 107 is joined with a transport motor, a gear, and the like (not shown), and is rotationally driven actively by the driving of the transport motor. The intermediate roller 107 rotates in a clockwise direction of FIG. 15. An intermediate driven roller 107a is provided so as to face the intermediate roller 107 with the paper 6 in between.

The paper 6 is further transported along the transport guide 106 as the intermediate roller 107 is rotationally driven. When a leading end of the paper 6 passes through the curved portion of the transport guide 106, the leading end of the paper 6 advances substantially parallel along a horizontal portion 106a of the transport guide 106 toward the front surface 101b of the printer 101. When the paper 6 advances substantially horizontally, the paper 6 reaches the multi-feed detection device 50. The multi-feed detection device 50 is installed in the first transport path 112 of the paper 6 and detects whether or not two or more sheets of paper 6 are overlapped. The multi-feed detection device 50 is the same device as the multi-feed detection device 50 described in the first embodiment. The multi-feed detection device 50 includes the ultrasonic receiver 27 and the ultrasonic transmitter 31. The area of the cross-section of the ultrasonic wave 56 cut along the receiving surface 66a is wider than the area of the receiving surface 66a. The multi-feed detection device 50 is a device that can be easily assembled. Accordingly, the printer 101 can be a device including the multi-feed detection device 50 with good assembly.

When the paper 6 advances to the front surface 101b side, the leading end of the paper 6 reaches a paper end sensor 108. The paper end sensor 108 has a light emitting unit and a light receiving unit (not shown). The leading end of the paper can be detected by determining whether or not the paper 6 is interrupting an optical path between the light emitting unit and the light receiving unit. The leading end of the paper is detected by the paper end sensor 108, the transport motor is subsequently driven, and the paper 6 is transported to the downstream of the transport path. A transport roller 109 is provided on the front surface 101b side of the paper end sensor 108, and the outer circumference of the transport roller 109 comes into contact with the paper 6 from the lower side. The transport roller 109 is joined with a transport motor, a gear, and the like (not shown), and is rotationally driven by the driving of the transport motor. In FIG. 15, the transport roller 109 rotates in a counterclockwise direction. A transport driven roller 109a is provided so as to face the transport roller 109 with the paper 6 in between. When the leading end of the paper reaches the transport roller 109, the paper 6 is transported by the transport roller 109.

A platen 110 is provided on the front surface 101b side of the transport roller 109, and the platen 110 supports the transported paper 6 from the below in FIG. 15. A carriage 111 is provided above the platen 110 in FIG. 15 with the paper 6 interposed therebetween. The carriage 111 includes a print head 111a on the lower side in FIG. 15. A large number of nozzles are arrayed and installed on a surface on the lower side of the print head 111a in FIG. 15, and ink is ejected from each nozzle. The carriage 111 moves in a direction perpendicular to the paper surface of FIG. 15. The movement of the carriage 111 in this direction is referred to as main scanning. While the carriage 111 performs main scanning, the print head 111a ejects ink on the paper 6. The print head 111a can draw a raster line along a main scanning axis with respect to a region facing the nozzles. After performing the main scanning, by driving the transport motor and transporting the paper 6, the printing position on the paper 6 can be shifted. Transporting the paper 6 for drawing is referred to as sub-scanning. By performing sub-scanning on the paper 6, the raster line can be drawn at a position different on the paper 6. By sequentially repeating the main scanning and the sub-scanning, the printer 101 forms a print image on the paper 6. The paper 6 on which the print image is formed is discharged to the paper discharge tray 104. The path through which the paper 6 is transported from the front paper feed tray 102 to the paper discharge tray 104 is the first transport path 112.

Next, transport of the paper 6 through the second transport path 116 will be described. As a mechanism member for supplying the paper 6 placed on the rear paper feed tray 103 to the second transport path 116, the printer 101 has a load roller 113, a load driven roller 114, a hopper 115, and the like. The load roller 113 is disposed so as to be rotatable adjacent to a lower end edge of the rear paper feed tray 103. The load roller 113 is joined with an auto sheet feeder motor, a gear, and the like (not shown). The load roller 113 rotates in a clockwise direction in FIG. 15 by the driving of the auto sheet feeder motor. The load roller 113 and the load driven roller 114 contact each other at a position near the lower end edge of the rear paper feed tray 103.

The hopper 115 is disposed so that the lower side of the rear paper feed tray 103 swings in a direction approaching the load roller 113 and in a direction away from the load roller 113. The hopper 115 approaches the load roller 113 so that the leading end of the uppermost paper 6 on the rear paper feed tray 103 hits the load roller 113, and this paper 6 is interposed between the hopper 115 and the load roller 113. By rotating the load roller 113 in this situation, the paper 6 is sandwiched between the load roller 113 and the load driven roller 114 and transported to the front surface 101b side.

The paper 6 transported by the rotation of the load roller 113 passes through the multi-feed detection device 50. The multi-feed detection device 50 is installed in the second transport path 116 of the paper 6, and detects whether or not two or more sheets of paper 6 are overlapped. The multi-feed detection device 50 is the same device as the multi-feed detection device 50 described in the first embodiment.

Next, the leading end of the paper 6 reaches the paper end sensor 108. The leading end of the paper 6 further transported to the front surface 101b side by the rotation of the load roller 113 passes through the paper end sensor 108 and reaches the transport roller 109. The paper 6 is transported on the platen 110 by the transport roller 109. The print image is formed by repeating the main scanning of the carriage 111 and the sub-scanning of the paper 6. The path through which the paper 6 is transported from the rear paper feed tray 103 to the paper discharge tray 104 is the second transport path 116. A transport path 117 is configured of the first transport path 112 and the second transport path 116.

As described above, according to the present embodiment, it has the following effects.

(1) According to the present embodiment, the printer 101 includes the transport path 117. The multi-feed detection device 50 is installed in the transport path 117, and the multi-feed detection device 50 detects whether or not two or more sheets of paper 6 are overlapped. For the multi-feed detection device 50, the multi-feed detection device 50 in the first embodiment is used. The multi-feed detection device 50 is a device that can be easily assembled. Accordingly, the printer 101 can be a device including the multi-feed detection device 50 with good assembly.

The present embodiment is not limited to the above-described embodiments, and various modifications and improvements can be made by those having ordinary knowledge in the art within the technical idea of the present disclosure. Modification examples will be described below.

### Modification Example 1

In the first embodiment, the ultrasonic transmitter 31 is installed on the upper substrate 29, and the ultrasonic receiver 27 is installed on the lower substrate 12. The ultrasonic wave 56 is transmitted from the +Z direction side of the paper 6, and the ultrasonic wave 56 is received from the -Z direction side of the paper 6. The positions of the ultrasonic receiver 27 and the ultrasonic transmitter 31 may be exchanged. Here, the multi-feed detection device 50 can detect multi-feed, and can be easily assembled.

### Modification Example 2

In the first embodiment, the entire ultrasonic receiving elements 68 of the receiving element substrate 66 are connected in parallel. A plurality of groups of the ultrasonic receiving elements 68 connected in parallel may be installed on the receiving element substrate 66. Since respective groups are connected in parallel, the reception state of the ultrasonic wave 56 can be efficiently output.

### Modification Example 3

In the first embodiment, whether the number of paper 6 passing through the multi-feed detection device 50 is zero, one, or two is detected. The multi-feed detection device 50 may detect a state where three or more sheets of paper 6 are overlapped. Detection suitable for the electronic device may be performed.

### Modification Example 4

In the first embodiment, the comparator circuit 88 compares the output voltage of the peak hold circuit 87 with the multi-feed determination voltage 97. The CPU 14 of the control unit 13 may determine whether or not the paper is in a multi-feed state using the output of the A/D converter circuit 89. The multi-feed determination voltage 97 can be easily switched when changing the material of the paper 6.

### Modification Example 5

In the first embodiment, the ultrasonic transmission elements 57 of the ultrasonic transmitter 31 are arranged in a matrix. In the ultrasonic receiver 27, the ultrasonic receiving elements 68 are arranged in a matrix. Alternatively, the ultrasonic receiving elements 68 may be disposed in a row by arranging the ultrasonic transmission elements 57 in a matrix. Alternatively, the ultrasonic receiving elements 68 may be arranged in a matrix by disposing the ultrasonic transmission elements 57 in a row. Alternatively, the ultrasonic transmission elements 57 may be disposed in a row, and the ultrasonic receiving elements 68 may also be disposed in a row. Here, the area of the cross-section of the ultrasonic wave 56 cut along the receiving surface 66a can be wider than the area of the receiving surface 66a.

Hereinafter, contents derived from the embodiment will be described.

A multi-feed detection device includes a substrate on which an ultrasonic transmitter transmitting an ultrasonic wave is installed, and an ultrasonic receiver having a receiving surface which receives the ultrasonic wave, in which the ultrasonic transmitter transmits the ultrasonic wave in a direction intersecting a thickness direction of the substrate, and an area of a cross-section of the ultrasonic wave cut along the receiving surface is wider than an area of the receiving surface.

According to this configuration, the multi-feed detection device includes a substrate on which an ultrasonic transmitter is installed and an ultrasonic receiver. The ultrasonic receiver receives the ultrasonic wave transmitted from the ultrasonic transmitter. When there is a sheet-like detection target in the course of the ultrasonic wave, as the number of the detection targets increases, the intensity of the ultrasonic wave passing through the detection target decreases, so that the multi-feed detection device can detect multi-feed of the detection target. The detection target indicates a medium such as a paper.

The ultrasonic transmitter transmits the ultrasonic wave in a direction diagonally intersecting a thickness direction of the substrate. When advancing the detection target in a planar direction of the substrate, the reflected wave of the ultrasonic wave reflected on the detection target advances in a direction different from the direction of the ultrasonic transmitter. Accordingly, it is possible to suppress the ultrasonic wave transmitted from the ultrasonic transmitter interfering with the reflected wave.

The ultrasonic receiver receives the ultrasonic wave on a receiving surface. The area of the cross-section of the ultrasonic wave cut along the receiving surface is wider than the area of the receiving surface. That is, the ultrasonic wave applied to the receiving surface is wider than the receiving surface. Accordingly, the relative position between the substrate and the ultrasonic receiver can be easily adjusted so that the receiving surface can receive the ultrasonic wave. As a result, the multi-feed detection device can be easily assembled.

In the multi-feed detection device, a plurality of ultrasonic receiving elements may be connected in parallel and disposed on the receiving surface.

According to this configuration, a plurality of ultrasonic receiving elements are connected in parallel and disposed on the receiving surface. Here, since the plurality of ultrasonic receiving elements are electrically connected with a common wiring, the wiring structure can be simplified. Accordingly, since the portion of the wiring occupying the receiving surface is reduced, the ultrasonic receiver can efficiently receive the ultrasonic wave.

The electronic device of the present application includes a multi-feed detection device installed in a transport path of a medium and detecting whether or not two or more media are overlapped, in which the multi-feed detection device is the multi-feed detection device described above.

According to this configuration, the electronic device includes a transport path. A multi-feed detection device is installed in the transport path, and the multi-feed detection device detects whether or not two or more media are overlapped. The above-described multi-feed detection device is used for the multi-feed detection device. The above-described multi-feed detection device is a device that can be easily assembled. Accordingly, the electronic device can be a device including the multi-feed detection device with good assembly.

What is claimed is:

1. A multi-feed detection device comprising:
a substrate on which an ultrasonic transmitter transmitting an ultrasonic wave is installed; and
an ultrasonic receiver having a receiving surface which receives the ultrasonic wave, wherein
the ultrasonic transmitter transmits the ultrasonic wave in a direction intersecting a thickness direction of the substrate, and
an area of a cross-section of the ultrasonic wave cut along the receiving surface is wider than the area of the receiving surface.

2. The multi-feed detection device according to claim 1, wherein
a plurality of ultrasonic receiving elements are connected in parallel and disposed on the receiving surface.

3. An electronic device comprising:
a multi-feed detection device installed in a transport path of a medium and detecting whether or not two or more media are overlapped, wherein
the multi-feed detection device is the multi-feed detection device according to claim 1.
